(19) United States
(12) Patent Application Publication
(10) Pub. No.: US 2006/0233934 A1
(43) Pub. Date: Oct. 19, 2006

(54) Beverage additive mixture of trehalose and protein

(76) Inventor: Hans Zoerb, River Falls, WI (US)

Correspondence Address: CARGILL, INCORPORATED, LAW/24, 15407 MCGINTY ROAD WEST, WAYZATA, MN, 55391, US

(21) Appl. No.: 10/559,504

(22) PCT Filed: Jun. 4, 2004
(86) PCT No.: PCT/US04/17814

§ 371 Date: May 22, 2006

(30) Foreign Application Priority Data
Jun. 5, 2003 (US) 60476252

(51) Int. Cl. A23L 2/00

(52) U.S. Cl. 426/590

(57) ABSTRACT

The invention provides an additive for a beverage. The additive comprises a mixture containing one or more normally bitter/cardboard-tasting proteins and trehalose. Although the additive contains at least one normally bitter/cardboard-tasting protein, the additive unexpectedly has a substantially neutral effect on the flavor of the beverage. The invention also provides for the simplicity of processing and storing the mixture in dehydrated form. The mixture is dehydrated, and then rehydrated before or during its addition to a beverage. The dehydration and subsequent rehydration permits processing, preserving, handling, and storing benefits—with substantially no damage to the protein or to the additive. The invention provides the additive and beverages containing the additive. In addition, the invention provides methods for preparing the additive and methods for preparing a flavored beverage.

### FIELD OF THE INVENTION

The invention relates to nutritional additives for beverages. More particularly, the invention relates to nutritional additives comprising trehalose and a normally bitter/cardboard-tasting protein. The invention generally relates to such additives and to associated processing benefits and flavor benefits.

### BACKGROUND

In view of the accelerating pace of business and other aspects of life, people often seek methods to accomplish multiple objectives in shorter times. An attractive time-saver for people with busy schedules is finding methods to combine meals more effectively into their activities. Such people often seek high nutrition foods that are readily available and can be consumed quickly. Hence beverages with enhanced nutritional value from a nutritional supplement become attractive.

Protein is an important nutritional source for such beverages. For example, whey protein is an important food ingredient known for its functionality in food systems as well as its nutritive value as a complete protein. As an example, in health and sports applications, whey protein's significant levels of branched-chain amino acids make it a desirable component in supplements for muscle regeneration during and following exercise. Specific components of whey have been identified with certain health claims, such as reduction in blood pressure and enhancement of the immune system. Unfortunately, whey and other useful proteins commonly have a bitter/cardboard-tasting flavor which creates a distinctive off-flavor in beverages. In addition the use of whey or other proteins can create processing difficulties. For example, if the whey or other protein is dehydrated to enable simpler storage, the protein can easily denature and lose value as a protein.

It would be important to the beverage industry if an additive were available which allowed the use of whey protein or other normally bitter/cardboard-tasting proteins, but had a neutral effect on the flavor of the beverage. It also would be important, if such an additive could be prepared as a dehydrated mixture for storage, and then could be easily rehydrated for addition to the beverage. Finally, it would be important, if the protein was substantially undamaged when it was rehydrated.

### SUMMARY OF THE INVENTION

The invention unexpectedly provides the needed additive. It provides a mixture of trehalose and one or more normally bitter/cardboard-tasting proteins. The mixture can be dehydrated for storage and then rehydrated with substantially no damage to the protein. Further, the dehydrated or rehydrated mixture—upon addition to a beverage—has a substantially neutral effect on the flavor of the beverage.

One aspect of the invention relates to a method for preparing a flavored beverage. The method comprises the following steps: (1) adding trehalose to a normally bitter/cardboard-tasting protein; wherein the trehalose is substantially distributed throughout the normally bitter/cardboard-tasting protein; and wherein the trehalose and the normally bitter/cardboard-tasting protein form a mixture; (2) removing water from the mixture, wherein the mixture is substantially dehydrated; (3) adding the mixture to a flavored beverage; wherein the mixture has a substantially neutral effect on the flavor of the beverage.

Another aspect of the invention relates to a method for preparing a flavored beverage. The method comprises the following steps: (1) adding trehalose to whey protein; wherein the trehalose is substantially distributed throughout the whey protein; and wherein the trehalose and the whey protein form a mixture; (2) removing water from the mixture, wherein the mixture is substantially dehydrated; (3) adding the mixture to a flavored beverage; wherein the mixture has a substantially neutral effect on the flavor of the beverage.

Another aspect of the invention relates to a method for preparing an additive for a beverage. The method comprises the following steps: (1) adding trehalose to a normally bitter/cardboard-tasting protein; wherein the trehalose is substantially distributed throughout the normally bitter/cardboard-tasting protein; and wherein the trehalose and the normally bitter/cardboard-tasting protein form a mixture; (2) removing water from the mixture; wherein the mixture is substantially dehydrated; (3) formulating the substantially dehydrated mixture into at least part of the additive; wherein the additive has a substantially neutral effect on the flavor of the beverage.

Another aspect of the invention relates to a method for preparing an additive for a beverage. The method comprises the following steps: (1) adding trehalose to whey protein; wherein the trehalose is substantially distributed throughout the whey protein; and wherein the trehalose and the whey protein form a mixture; (2) removing water from the mixture; wherein the mixture is substantially dehydrated; (3) formulating the substantially dehydrated mixture into at least part of the additive; wherein the additive has a substantially neutral effect on the flavor of the beverage.

Another aspect of the invention relates to an additive for a beverage. The additive comprises a normally bitter/cardboard-tasting protein and trehalose; wherein the trehalose is substantially distributed throughout the normally bitter/cardboard-tasting protein; wherein the normally bitter/cardboard-tasting protein and trehalose form a substantially dehydrated mixture; and wherein the additive has a substantially neutral effect on the flavor of the beverage.

Another aspect of the invention relates to an additive for a beverage. The additive comprises whey protein and trehalose; wherein the trehalose is substantially distributed throughout the whey protein; wherein the whey protein and trehalose form a substantially dehydrated mixture; and wherein the additive has a substantially neutral effect on the flavor of the beverage.

A further aspect of the invention relates to a beverage. The beverage comprises an additive; wherein the additive comprises a normally bitter/cardboard-tasting protein and trehalose; wherein the trehalose is substantially distributed throughout the normally bitter/cardboard-tasting protein; wherein the normally bitter/cardboard-tasting protein and trehalose form a substantially dehydrated mixture; and wherein the additive has a substantially neutral effect on the flavor of the beverage.

A further aspect of the invention relates to a beverage. The beverage comprises an additive; wherein the additive comprises whey protein and trehalose; wherein the trehalose is substantially distributed throughout the whey protein; wherein the whey protein and trehalose form a substantially dehydrated mixture; and wherein the additive has a substantially neutral effect on the flavor of the beverage.

An even further aspect of the invention relates to flavored beverages prepared by the various methods described herein.

A still further aspect of the invention relates to additives for beverages prepared by the various methods described herein.

### DETAILED DESCRIPTION OF THE INVENTION

Definitions

beverage—The term as used herein includes the following: 1) beverages into which the additive of the invention may be added, 1) beverages into which the additive of the invention is being added, and 1) beverages into which the additive of the invention has been added.

dehydration—Removal of water, using heat, vacuum, or other drying processes, from a solution containing one or more solutes such that the remaining product is a substantially free-flowing powder of less than about 10% moisture, unable to support and sustain microbial growth, and stable in storage at ambient temperatures.

normally bitter/cardboard-tasting protein—The normally bitter/cardboard-tasting proteins contemplated by the invention comprise whey protein, soy protein, and casein protein. The specific term “normally bitter/cardboard-taste” is easily characterized by the strong bitter and cardboard taste normally associated with whey protein, soy protein, and casein protein.

rehydration—Addition of water to a dry protein powder such that the powder is fully dissolved, and that the various components are returned to native or near native structure and functionality.

Abbreviations

% percent; described on a weight/weight basis unless otherwise indicated

deg F degrees Fahrenheit

psi pounds per square inch gage

TREₐ trehalose in amorphous from

TREₐₗₚₕₐ trehalose in an alternate anhydrous crystal form (alternate to TRE_{beta})

TRE_{beta} trehalose in an anhydrous crystal form

TREₕ trehalose in dihydrate crystal form

T_{g} glass transition temperature

WPI whey protein isolate

Detailed Description

The invention provides an additive for a beverage with unexpected results. The additive comprises a mixture containing one or more normally bitter/cardboard-tasting proteins and trehalose. Although the additive contains at least one normally bitter/cardboard-tasting protein, the additive unexpectedly has a substantially neutral effect on the flavor of the beverage.

The invention also provides for the simplicity of processing and storing the mixture in dehydrated form. The mixture is dehydrated, and then rehydrated before or during its addition to a beverage. The dehydration and subsequent rehydration permits processing, preserving, handling, and storing benefits—with substantially no damage to the protein or to the additive.

The normally bitter/cardboard-tasting proteins contemplated by the invention comprise whey protein, soy protein, and casein protein. The term “normally bitter/cardboard-taste” is easily characterized by the strong bitter and cardboard taste normally associated with whey protein, soy protein, and casein protein.

The normally bitter/cardboard-tasting proteins contemplated by the invention include proteins in isolate form, concentrate form, and hydrolyzate form. For example, the invention contemplates whey protein isolate, whey protein concentrate, whey protein hydrolyzate, soy protein isolate, soy protein concentrate, soy protein hydrolyzate, casein protein isolate, casein protein concentrate, and casein protein hydrolyzate.

The mixture of trehalose and normally bitter/cardboard-tasting protein can contain relative amounts of trehalose to protein ranging from weight ratios of about 5/95 to about 99/1. Although ratios of about 20/80 to about 99/1 are preferred, the specific weight ratio is not believed critical. It is believed that a certain amount of trehalose is needed to support the effects of the invention (such as 5% trehalose). However, the effects of the invention are expected to occur for virtually any amount of protein as long as sufficient trehalose (such as 5% trehalose) is present. Although the specific weight ratio is not believed critical, a ratio of about 50/50 has been experimentally evaluated by the inventors.

Beverages contemplated by the invention comprise: (1) Sport Beverages, such as Gatorade, Powerade, and other similar beverages; (2) Meal Replacement Beverages, such as yogurt based drinks such as Smoothie, milk based drinks, soy based drinks, and other similar beverages; (3) Nutritional Supplement Beverages, such as Slim Fast, and other similar beverages; (4) Fruit Juices, (5) Soda Pop, and (6) other similar beverages. It is believed that the invention is useful for virtually any beverage for which a nutritional supplement is desired.

The amount, of normally bitter/cardboard-tasting protein, within the mixture added to the beverage, can range such that the normally bitter/cardboard-tasting protein makes up about 0.5% to about 20% of the beverage. A preferred range is about 1% to about 10%. The specific amount of normally bitter/cardboard-tasting protein is controlled by nutritional, texture, flavor, and cost considerations. Although the specific amount of the normally bitter/cardboard-tasting protein is not believed critical, an amount of about 1.67% has been experimentally evaluated by the inventors.

Trehalose is a glucose disaccharide with an alpha 1-1 glycosidic link making it a symmetric sugar with multiple applications in food and pharmaceutical applications. Trehalose is polymorphic in the solid phase. In addition to the stable dihydrate crystal, TREₕ; the molecule also has an anhydrous crystal form, TRE_{Beta}, and an amorphous form, TREₐ. Under mildly elevated temperature and vacuum, an alternative anhydrous crystal, TREₐₗₚₕₐ, can be formed. TREₐₗₚₕₐ retains the crystal architecture of TREₕ because the rate of moisture removal does not allow the molecule to relax to a more compact structure. Exposure to moisture will rapidly change TREₐₗₚₕₐ to TREₕ. High heat and vacuum melts the TREₕ crystal and removes water rapidly resulting in formation for TRE_{Beta}. Another important property of trehalose is its particularly high glass transition temperature, T_{g}, (comparable with maltotetraose) for a disaccharide.

Trehalose was added to a normally bitter/cardboard-tasting protein—a whey protein isolate (WPI) called BiPro™ from Davisco Foods, Incorporated. The trehalose was added in solution at a level equal to the WPI solids content. The resulting solution was spray-dried to yield a stable powder containing 50% trehalose and 50% whey protein isolate on a dry weight basis. The structure of the resulting powder was a protein particle encapsulated by trehalose and was measured to be about 300 microns in size. The trehalose component of the particle was amorphous (as determined by differential scanning calorimetry). This co-dried mixture was used as the primary protein ingredient and as a carbohydrate ingredient in a 4:1 carbohydrate to protein beverage. The protein was found to be rehydrated within the drink such that its various components were returned to native or near native structure and functionality. In addition the co-dried mixture resulted in a cleaner flavor with less objectionable protein off-flavors when compared to similar levels of the same protein and trehalose added as separate components. It was also observed that trehalose when co-dried with protein results in retarded Mailard browning in solutions containing reducing sugars. Hence it was concluded, that when spray-dried together, trehalose stabilizes the proteins during the drying process and storage, and has the potential to mitigate other undesirable effects of protein in food.

Carbohydrates, especially oligosaccharides, are known to have certain protein stabilizing effects. For example, it is known that trehalose can stabilize a protein during dehydration and rehydration such that the protein is not, or is minimally, denatured upon rehydration. Such findings are reported by Sussich et al in “Reversible dehydration of trehalose and anhydrobiosis from solution state to an exotic crystal”, Carbohydrate Research, vol 443, 2001, pp 165-176; and in Murray and Liang in “Enhancement of the foaming properties of protein dried in the presence of trehalose”, Journal of Agriculture Food Chemistry, vol 47, 1999, pp 4894-4991. However, the present invention has demonstrated that trehalose can unexpectedly mitigate the development of off-flavors resulting from proteins in beverage supplements, significantly better than other sugars. As demonstrated herein, when spray-dried with food proteins from native solution, the trehalose has a significantly effective impact on flavor. The trehalose also displays an improved effect on certain other functionality. For example, trehalose dissolves more rapidly in water than many other sugars (such as sucrose or glucose), and as a co-solute facilitates the dissolution or dispersion of proteins and other less soluble or less dispersible molecules.

The above brief summary of improvements will become apparent to one of ordinary skill in the art from the following examples. The examples are intended to illustrate the spirit of the invention and certain embodiments of the invention, but not to restrict the invention. One of ordinary skill in the art, after reading the present disclosure of the invention, will be able to envision additional embodiments. It is the intent of the inventors that all such embodiments are included in the invention.

### EXAMPLES

### Example 1

Spray drying of a mixture of trehalose and whey occurred at Davisco Food's processing facility at Le Sueur, Minn. Two hundred sixty four (264) pounds of crystalline trehalose dihydrate (90% trehalose) was blended using a standard propeller mixer into one thousand eighty (1080) pounds of a 22% whey protein isolate solution (BiPro™) to yield a solution containing 17.6% trehalose and 17.6% WPI. The solution was blended at 50 deg F. for 20 minutes until it was determined that the trehalose was completely dissolved. The resultant blend was spray-dried in Davisco's Coulter dryer at the following parameters, which are typical of those used to dry their whey protein isolate:
Inlet temperature—385 to 395 deg F.
Nozzle pressure—850+/−35 psi
Outlet temperature—205 to 215 deg F.
Target moisture—6.0 to 4.5%
Drying rate—200 pounds per hour
Retention time—2 minutes
Cooling temperature—50 deg F.
   The resultant mixture was a powder. The structure of the resultant powder was a protein particle encapsulated by trehalose and was measured to be about 300 microns in size. The resultant mixture is herein called BT-100.

### Example 2

Samples of the Trehalose/BiPro™ mixture prepared in Example 1 were added to a 4:1 carbohydrate to protein water-based beverage to produce a protein fortified ready-to-drink beverage.

The mixture was added to the drink using a procedure which comprises the following steps:
1. The BT-100 (the Trehalose/BiPro™ mixture prepared in example 1) was mixed with sucrose. The total blend was then added slowly to water. Sufficient time was allowed for the BT-100 and the sucrose to be completely dissolved.
2. Add sodium citrate and monopotassium phosphate with mild agitation.
3. Add 50% of the acidulent blend slowly and allow solution to mix for 15 minutes. Measure the pH. If pH is not less than 3.5 add 25% of the acidulent blend (half of that remaining), again allowing the solution to mix for 15 minutes taking pH measurements to ensure the pH does not drop below 3.4. Add remainder of the acidulent blend until pH reaches 3.3.
4. Add flavor
5. Add color
6. Agitate for 15 minutes and measure the pH to ensure that it is 3.3.
7. Heat to 190 F for 30 seconds and hot-fill into suitable packaging and cool immediately.

The formula for the drink after the addition of the mixture is described in Table 1:

TABLE 1
Formula for the drink prepared in Example 2 and the drink prepared in
Comparative Example 1

| | | | Concentration (%) for | |
|---|---|---|---|---|
| | | | Comparative Example 1, | |
| | Concentration (%) for | | wherein the Trehalose and | |
| | Example 2, wherein the | | the BiPro ™ were | |
| | Trehalose/BiPro ™ | | added as separate | |
| | mixture was added to the | | components to | |
| Component | beverage. | | the beverage. | |
| Water | 89.93 | | 89.93 | |
| Sucrose | 5.00 | | 5.00 | |
| Whey Protein | 1.67 | WPI and | 1.67 | WPI and Trehalose |
| Isolate | | Trehalose | | added to beverage |
| Trehalose | 1.67 | added to | 1.67 | as separate |
| | | beverage as | | components |
| | | mixture | | |

| | | |
|---|---|---|
| Citric Acid | 0.45 | 0.45 |
| Phosphoric Acid | 0.15 | 0.15 |
| Lactic Acid | 0.10 | 0.10 |
| Sodium Citrate | 0.25 | 0.25 |
| Monopotassium | 0.20 | 0.20 |
| Phosphate | | |
| Flavor | 0.63 | 0.63 |
| Color | 0.05 | 0.05 |

### Comparative Example 1

Trehalose dihydrate and the BiPro™ protein were added as separate components to the same beverage used in Example 2 to produce a protein fortified ready-to-drink beverage.

The separate components were added to the drink using a procedure which comprises the following steps:
1. The BiPro™ whey protein isolate was mixed with the sucrose and trehalose. The total blend was then added slowly to water. Sufficient time was allowed for the BiPro™ whey protein isolate, the sucrose, and the trehalose to be completely dissolved.
2. Add sodium citrate and monopotassium phosphate with mild agitation.
3. Add 50% of the acidulent blend slowly and allow solution to mix for 15 minutes. Measure the pH. If pH is not less than 3.5 add 25% of the acidulent blend (half of that remaining), again allowing the solution to mix for 15 minutes taking pH measurements to ensure the pH does not drop below 3.4. Add remainder of the acidulent blend until pH reaches 3.3.
4. Add flavor
5. Add color
6. Agitate for 15 minutes and measure the pH to ensure that it is 3.3.
7. Heat to 190 F for 30 seconds and hot-fill into suitable packaging and cool immediately.

The formula for the drink after the addition of the Trehalose dihydrate and the BiPro™ protein is described in Table 1:

### Example 3

The formulations prepared in Example 2 and Comparative Example 1 were tested for overall taste, bitter protein taste, and cardboard protein taste by experts experienced in the field.

Results from the sensory test are listed in Table 2.

TABLE 2
Results form the sensory taste test described in Example 3.

| | Result for | |
|---|---|---|
| | Example 2, | |
| | wherein the | Result for Comparative Example 1, |
| | Trehalose/BiPro ™ | wherein the Trehalose and the |
| Sensory | mixture was added | BiPro ™ were added as separate |
| Property | to the beverage. | components to the beverage. |
| Overall | Substantially | Bitter, cardboard taste |
| flavor | no bitter, | |
| | cardboard | |
| | taste | |
| Bitter | Substantially | Strong |
| protein | no bitter | |
| taste | taste | |
| Cardboard | Substantially | Strong |
| protein | no | |
| taste | cardboard | |
| | taste | |

As illustrated by the data in Table 2, the beverage formulated in Example 2 resulted in a cleaner flavor than the beverage formulated in Comparative Example 1. In particular, the Example 2 beverage lacked the strong bitter protein taste and the strong cardboard protein taste of the Comparative Example 1 beverage. It was concluded that the additive of Example 2 had a substantially neutral effect on the flavor of the beverage.

Having illustrated and described the principles of the invention in multiple embodiments and examples, it should be apparent to those skilled in the art that the invention can be modified in arrangement and detail without departing from such principles. We claim all modifications coming within the spirit and scope of the following claims.

We claim:

1. A method for preparing a flavored beverage, comprising the following steps:
a) adding trehalose to a normally bitter/cardboard-tasting protein; wherein the trehalose is substantially distributed throughout the normally bitter/cardboard-tasting protein; and wherein the trehalose and the normally bitter/cardboard-tasting protein form a mixture;
b) removing water from the mixture, wherein the mixture is substantially dehydrated;
c) adding the mixture to a flavored beverage; wherein the mixture has a substantially neutral effect on the flavor of the beverage.

2. A method for preparing a flavored beverage, comprising the following steps:
a) adding trehalose to whey protein; wherein the trehalose is substantially distributed throughout the whey protein; and wherein the trehalose and the whey protein form a mixture;
b) removing water from the mixture, wherein the mixture is substantially dehydrated;
c) adding the mixture to a flavored beverage; wherein the mixture has a substantially neutral effect on the flavor of the beverage.

3. The method described in claim 1, wherein the normally bitter/cardboard-tasting protein is selected from the group consisting of soy protein and casein protein.

4. The method described in claim 1, wherein the normally bitter/cardboard-tasting protein is in a form selected from the group consisting of isolate, condensate, and hydrolyzate.

5. The method described in claim 1, wherein the beverage is selected from the group consisting of sport beverages, meal replacement beverages, nutritional supplement beverages, fruit juices, and soda pop.

6. A method for preparing an additive for a beverage, comprising the following steps:
a) adding trehalose to a normally bitter/cardboard-tasting protein; wherein the trehalose is substantially distributed throughout the normally bitter/cardboard-tasting protein; and wherein the trehalose and the normally bitter/cardboard-tasting protein form a mixture;
b) removing water from the mixture; wherein the mixture is substantially dehydrated;
c) formulating the substantially dehydrated mixture into at least part of the additive; wherein the additive has a substantially neutral effect on the flavor of the beverage.

7. A method for preparing and additive for a beverage, comprising the following steps:
a) adding trehalose to whey protein; wherein the trehalose is substantially distributed throughout the whey protein; and wherein the trehalose and the whey protein form a mixture;
b) removing water from the mixture; wherein the mixture is substantially dehydrated;
c) formulating the substantially dehydrated mixture into at least part of the additive; wherein the additive has a substantially neutral effect on the flavor of the beverage.

8. The method described in claim 6, wherein the normally bitter/cardboard-tasting protein is selected from the group consisting of soy protein and casein protein.

9. The method described in claim 6, wherein the normally bitter/cardboard-tasting protein is in a form selected from the group consisting of isolate, condensate, and hydrolyzate.

10. The method described in claim 6, wherein the beverage is selected from the group consisting of sport beverages, meal replacement beverages, nutritional supplement beverages, fruit juices, and soda pop.

11. An additive for a beverage, comprising a normally bitter/cardboard-tasting protein and trehalose; wherein the trehalose is substantially distributed throughout the normally bitter/cardboard-tasting protein; wherein the normally bitter/cardboard-tasting protein and trehalose form a substantially dehydrated mixture; and wherein the additive has a substantially neutral effect on the flavor of the beverage.

12. An additive for a beverage, comprising whey protein and trehalose; wherein the trehalose is substantially distributed throughout the whey protein; wherein the whey protein and trehalose form a substantially dehydrated mixture; and wherein the additive has a substantially neutral effect on the flavor of the beverage.

13. The additive described in claim 11, wherein the normally bitter/cardboard-tasting protein is selected from the group consisting of soy protein and casein protein.

14. The additive described in claim 11, wherein the normally bitter/cardboard-tasting protein is in a form selected from the group consisting of isolate, condensate, and hydrolzate.

15. The additive described in claim 11, wherein the beverage is selected from the group consisting of sport beverages, meal replacement beverages, nutritional supplement beverages, fruit juices, and soda pop.

16. A beverage comprising an additive; wherein the additive comprises a normally bitter/cardboard-tasting protein and trehalose; wherein the trehalose is substantially distributed throughout the normally bitter/cardboard-tasting protein; wherein the normally bitter/cardboard-tasting protein and trehalose form a substantially dehydrated mixture; and wherein the additive has a substantially neutral effect on the flavor of the beverage.

17. A beverage comprising an additive; wherein the additive comprises whey protein and trehalose; wherein the trehalose is substantially distributed throughout the whey protein; wherein the whey protein and trehalose form a substantially dehydrated mixture; and wherein the additive has a substantially neutral effect on the flavor of the beverage.

18. The additive described in claim 16, wherein the normally bitter/cardboard-tasting protein is selected from the group consisting of soy protein and casein protein.

19. The additive described in claim 16, wherein the normally bitter/cardboard-tasting protein is in a form selected from the group consisting of isolate, condensate, and hydrolyzate.

20. The additive described in claim 16, wherein the beverage is selected from the group consisting of sport beverages, meal replacement beverages, nutritional supplement beverages, fruit juices, and soda pop.

21. The flavored beverage prepared by the method described in claim 1.

22. The additive prepared by the method described in claim 6.
